(19) United States
(12) Patent Application Publication
(10) Pub. No.: US 2021/0103514 A1
(43) Pub. Date: Apr. 8, 2021

(54) REUSABLE TEST CASES FOR IDENTIFIABLE PATTERNS

(71) Applicant: SAP SE, Walldorf (DE)

(72) Inventors: Sourav Das, Howrah (IN); Shruti Bansal, Bangalore (IN)

(21) Appl. No.: 16/595,794

(22) Filed: Oct. 8, 2019

(51) Int. Cl. G06F 11/36

(52) U.S. Cl. CPC G06F 11/3684; G06F 11/3664; G06F 11/3688

(57) ABSTRACT

Provided is a system and method for automatically testing code patterns using reusable test cases. In one example, the method may include receiving a software artifact comprising source code, identifying a pattern in the software artifact based on one or more methods within the source code and a variable consumed by the one or more methods, retrieving a reusable test case that is previously designated for testing the identified pattern, and automatically testing the identified pattern in the software artifact based on the reusable test case, and storing the testing results in a log file.

### BACKGROUND

A test case is used by a software developer to ensure software is working properly before production. For example, a test case may include a set of conditions, inputs, expected outputs, etc., which may be applied to the execution of source code. To fully test a software application, a battery of test cases can be built to produce the desired coverage of the software being tested. Because of this, the software development process can require a significant portion of time to be dedicated to the building and execution of test cases. Even after such dedicated efforts, the source code may contain bugs, overlooked issues, and the like, because it is subject to human implementation. For example, a manually developed test case may miss out on potential pitfalls in the code which are known to others but not known to the tester. In addition, code patterns are often repeated throughout different classes of source code. While the code patterns are the same, the associations, inheritance, and dependency usually change. In this scenario, a developer must write different test cases for each of these different source code patterns. Creating test cases and modifying tests cases (e.g., when a system changes, etc.) can occupy significant design time with little guarantee that code will not fail in production.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a test framework providing automated test cases in accordance with an example embodiment.

FIG. 1B is a diagram illustrating a test engine identifying a pattern from source code, in accordance with an example embodiment.

FIG. 1C is a diagram illustrating a test engine generating test data for a test cases in accordance with an example embodiment.

FIG. 1D is a diagram illustrating a process of pushing a new test case to a host platform in accordance with an example embodiment.

FIG. 2A is a diagram illustrating examples of software artifacts in accordance with an example embodiment.

FIG. 2B is a diagram illustrating an example of test code including a reusable test case in accordance with an example embodiment.

FIG. 3 is a diagram illustrating a user interface displaying results of automated testing in accordance with an example embodiment.

FIGS. 4A-4B are diagrams illustrating a process of adding a new test case to a pool of reusable test cases in accordance with an example embodiment.

FIG. 5 is a diagram illustrating a method of identifying and testing a pattern within a software artifact in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Software testing requires time and effort to build a test case (or in many cases a set of test cases) and apply them to source code of a software artifact under test. Traditionally, there are two types of software tests, technical tests and business logic tests. Technical tests check extremities and validate code based on a programming language. For example, technical tests may include null checks, extreme value checks, floating point validation, not a number (NAN) checks, and the like. Meanwhile, business logic tests are designed to test the source code to verify it performs the business operation it is intended to perform. Even with significant testing, there is no guarantee that a user is aware of all possible issues that can occur. Therefore, the testing is limited by the knowledge of the test developer.

The example embodiments provide a framework which implements reusable test cases for identifiable patterns within source code. Rather than require a developer to write a test case, the framework can identify a pattern read from the source code and test the source code using a previously designated reusable test case. The test case may include (or generate) inputs, execution conditions, procedures, expected outputs, and the like. The framework may execute the test case on the source code to determine whether, when processed by the source code, the expected outputs are generated from the inputs.

Similar patterns are present in many software classes and other software objects. The patterns may be identified based on content within the source code including methods, variables, interaction between the methods and variables, and the like. When the system identifies a predetermined pattern, the system may retrieve a reusable test case that is previously linked to the identified pattern. In some cases, the predetermined patterns may be stored at a central location which is accessible to a group of users. In the examples herein, software artifacts are shown and described as objects/classes in object-oriented programming languages such as Java. However, it should be appreciated that the example embodiments may work with code in any programming language.

To perform technical testing, the developer may only need to provide source code. In this case, the system can automatically check the source code for previously known patterns and identify whether any of these patterns are present in the source code. If identified, the system may automatically test the code pattern using already known test cases including inputs, outputs, procedures, conditions, etc. Test results can be output via a user interface, for example, via an integrated development environment (IDE) where the code is being written and tested. There are cases where not all source code can be linked to known patterns. Code that is not linked may not be tested, or it may be tested generically. In this case, the output may identify which source code was tested (e.g., using colors, shading, lines, indicators, etc.) and differently identify source code that was not tested to distinguish the two.

In addition to identifying patterns within the source code, the framework may identify or match the identified patterns to testing strategies for testing. A strategy may encompass multiple test cases corresponding to different testing scenarios such as null checks, extremities checks, string length validation, type checking, and the like. In addition to matching a pattern to a strategy (e.g., a set of test cases), the system may also generate test data (inputs) for the test cases. Each of the different test cases/scenarios may have its own respective test data that may be generated automatically by the platform. Furthermore, the framework also enables a user to test the source code in different granularities. For example, a user may choose to test a package of software (as a whole) during an initial test run. This granularity may be referred to as a package unit granularity. However, when the user has begun making changes and only desires to test/focus on a specific class or method of code, the framework also enables the user to select a class unit granularity, a method unit granularity.

The framework may initially provide a set of reusable test cases which have been built based on known patterns. In addition, the framework may also provide a user interface, etc., which allows new patterns to be provided along with corresponding test cases for the patterns. In this way, the pool of available patterns and corresponding test cases may continue to grow as coding styles change and new ideas come to fruition.

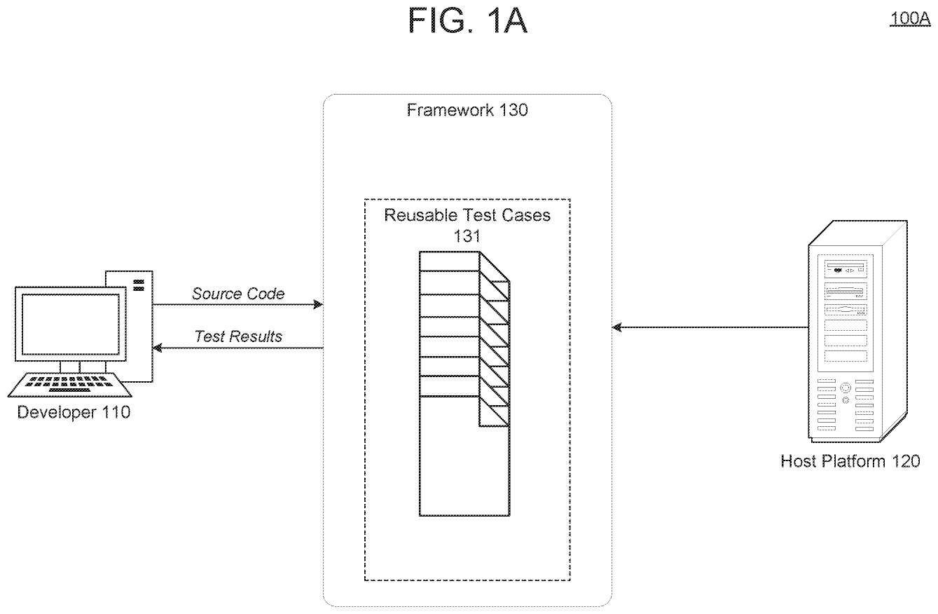

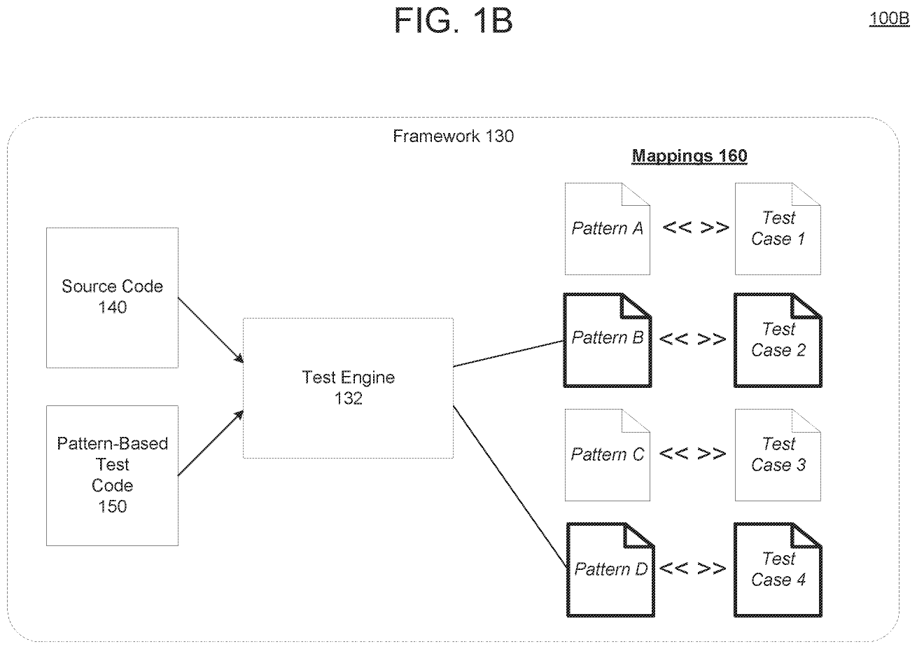

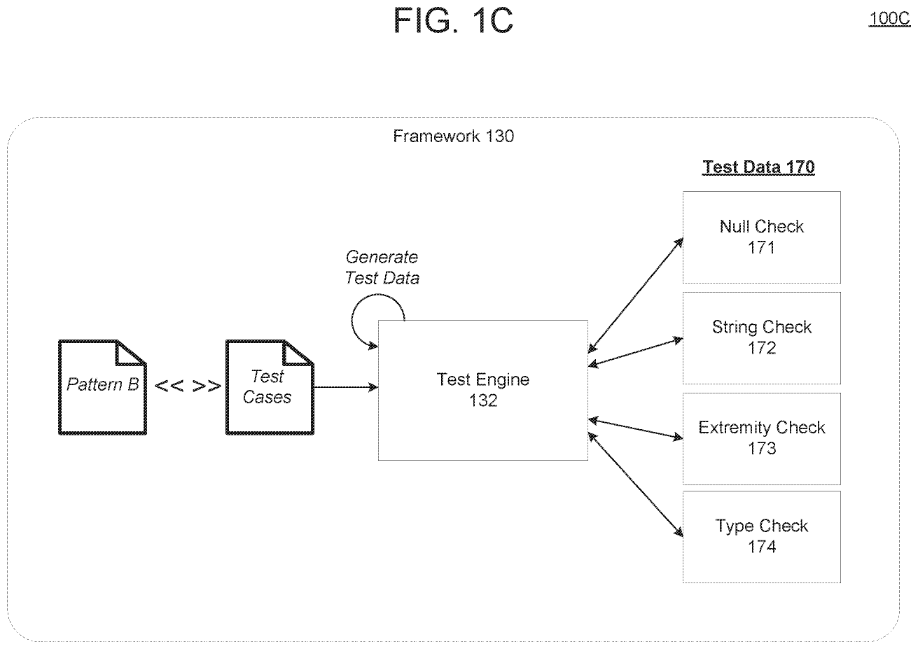

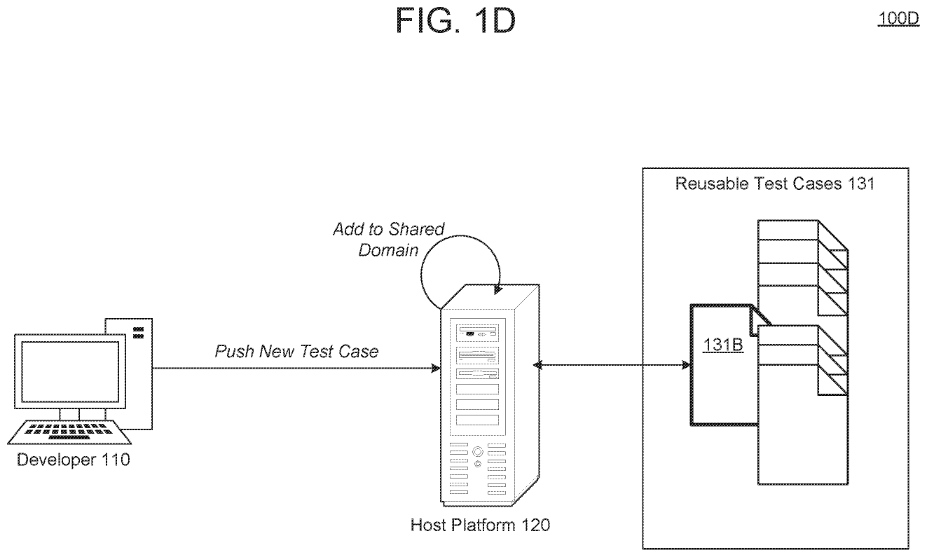

FIG. 1A illustrates a process 100A of a user interacting with a test framework 130 providing automated reusable test cases in accordance with an example embodiment, FIG. 1B illustrates process 100B of a test engine 132 identifying patterns in source code, in accordance with an example embodiment, FIG. 1C illustrates a process 100C of generating test data for test cases in accordance with an example embodiment, and FIG. 1D illustrates a process 100D of pushing a newly designed test case to a shared domain in accordance with an example embodiment. Referring to FIG. 1A, a developer may download the framework 130 including a test environment to a developer system 110 from a host platform 120 to perform software testing. For example, the developer system 110 may be a workstation, a personal computer, a mobile device, a laptop, a tablet, and the like. The host platform 120 may include a web server, an on-premises server, a cloud platform, a database, and the like. In some embodiments, the developer system 110 and the host platform 120 may connect to each other via a network such as the Internet. As another example, the developer system 110 and the host platform 120 may be incorporated into a single system.

In the example of FIG. 1A, the developer system 110 may test source code of a software artifact with the framework 130 in a local testing environment. This environment is referred to as runtime testing. For example, the software artifact may include an application, a program, a service, an object, a class, or the like. In some embodiments, the developer system 110 may further provide test data to the framework 130 which includes one or more of test inputs, expected outputs, and the like. The framework 130 may store a dynamically growing set of reusable test cases 131. For example, the reusable test cases 131 may include inputs, outputs, execution conditions, test procedures, and the like, for testing identifiable patterns in the source code added by the developer via the developer system 110. In some embodiments, the developer may also provide test code which includes identifiable patterns and reusable test cases 131. As another example, other users (not shown) may upload identifiable patterns and reusable test cases 131. As a result, the reusable test cases 131 may include an ever growing list.

Referring to FIG. 1B, a test engine 132 of the framework 130 identifies one or more test cases (or a strategy of test cases) based on a pattern identified from source code 140 provided from the developer, and automatically tests the pattern based on the mapped test cases. The results may be output to a user interface of the developer system 110.

The test cases may be paired with or otherwise include identifiable patterns that can be used by the test engine 132 of the framework 130 to scan the incoming source code 140. Here, when the test engine 132 identifies a known pattern in the source code 140, the test engine 132 may automatically test the pattern using a corresponding test case. The tester can use the reusable test cases 131 shown in FIG. 1A as a base for testing a respective software artifact. The use of reusable test cases 131 can ensure that known pitfalls are already taken care of (within the reusable test cases 131) when testing the respective software artifact. In addition, artifacts with similar/common patterns can use the same reusable test case instead of requiring a developer to author them, even for code patterns in different classes/languages. Below is an example (Example 1) of two different software artifacts (Class A and B) with common patterns.

| Class A | Class B |
|---|---|
| c = add (a, b) | x = add (y, z) |

### Example 1

In this example, both classes have a method takes two variables/arguments and returns a sum. In this example, both classes include methods for adding two numbers together. The assumption is that the purpose of the method is to add two parameters together to create a summation when the method has a name such as “add.” Traditionally, two different test cases were required to test each class individually despite both methods having a same purpose. However, according to various embodiments, a reusable test case can be written in an independent and generic way such that any class having such a pattern can be tested. Shown below is an example of an algorithm of a specific test code (ALGO) which works on any class. In this example, the test code can identify an add method in source code and then verify its parameters (variables). Next, the test code can generate inputs and pass them as arguments to the source code.

```
ALGO
  FIND add method in source code
  VERIFY it's parameters
  RANDOMLY generate integers to pass as arguments
  STORE the returned integers
  ASSERT the sum of the parameters with the returned object
END ALGO
```

### Example 2

The test code can operate on any kind of the classes within a programming language or framework with reflection capabilities. In other words, the reusable test case is class-agnostic. It should be appreciated that the examples may be extended to other types of programming languages.

Referring again to FIG. 1B, the test engine 132 may receive source code 140 from the developer and pattern-based test code 150 that includes mappings 160 between identifiable patterns and corresponding test cases for testing the identifiable patterns. This process 100B may be referred to as the runtime phase of the framework 130. In the example of FIG. 1B, four patterns A-D are paired with four test cases 1-4. In some embodiments, it should be appreciated that multiple test cases may be linked to a respective identifiable pattern. This may also be referred to as a strategy of test cases. In this example, the test engine 132 identifies pattern B and pattern D within the source code 140. Accordingly, the test engine 132 may execute test case 2 on the identified pattern B and test case 4 on the identified pattern D. The results may be output to the developer system 110.

A reusable test case applicable for a respective pattern can take care of any technical tests associated with the pattern. Meanwhile, the developer may focus solely on business logic testing of the source code. For example, referring to FIG. 1C, the test engine 132 of the framework 130 may automatically generate test data 170 and test the identified pattern (pattern B) from the source code based on the test data for logical validation including null checks 171, string length validation 172, extremities validation 173 such as integer and floating-point range validation, type checking 174, and the like. In some embodiments, user-defined test data for each of the different kinds of checks/test cases may be generated automatically using a mock data generator which uses reflection to generate an object at runtime. In this way, the framework 130 provides an additional tool that generates test data 170 for the patterns that are identified and that are to be tested. The generation of the test data can compliment the testing of the source code. The test data can be generated for multiple different scenarios for testing a pattern such as null checks, string length validation, type checking, and the like.

The test engine 132 may receive/accept the source code 140 and test code 150 which can be used to identify and test certain patterns within the source code 140. The test code 150 may also include test cases therein for testing the identified patterns. After testing is done, the results may be output such that identified/tested patterns are distinguished from source code 140 which was not tested. According to various embodiments, any source code having the same pattern can be tested with the same test case, as the test case are generic. A set of test cases may be included or pre-built into the local copy of the framework 130 stored on the developer's station 110. These known test cases can handle most of the pitfall checks of known patterns. In addition, when new test cases come available at the host platform 120, the new test cases may be imported into the local copy of the framework 130 on the developer system 110 from the host platform 120.

Referring to FIG. 1D, when a user develops a new test case 131B, such as for a section of source code that was not identified and tested automatically, the user may share the new test case 131B with other users by uploading/pushing it to the shared domain of the host platform 120. The process 100D may be referred to as the design time phase of the framework 130. In the example of FIG. 1D, the developer may upload the new test case 131B to the host platform 120 such that it becomes available for other users (not shown) to download and access. Likewise, other users may upload new test cases that can be downloaded/imported to the developer system 110. In some embodiments, the test cases may have a strict architecture and design enabling standardized format of the test cases, however, embodiments are not limited thereto. Also, test cases can be written in a generic way relieving developers from having to rewrite test cases of similar code patterns across different classes/languages.

As described herein, the source code 140 may include one or more methods, classes, etc., for testing. In some embodiments, the source code 140 may be checked with different granularities. For example, different granularities (unit sizes) of source code may be used to check for specific patterns. For example, testing may start out at the package level (package unit granularity) which attempts to map all classes of code to identifiable patterns. However, as testing continues, a developer may want to focus on specific classes or methods which have changed while not re-testing the entire package of source code. In this example, the user can specify bigger or smaller units of code (method units, class units, etc.) based on how much volume of code the developer desires to test.

In addition to the source code 140, the test code 150 may be input and may include patterns/test cases to be performed by the test engine 132 when it identifies a pattern. As described herein, a strategy may include code to recognize a pattern in a source code and the test code which can be used to test the recognized pattern. A test case refers to a particular scenario to be tested, and a strategy may include multiple test cases/scenarios to be tested.

In some embodiments, additional inputs may be provided to exclude pattern matching on some portions of the source code by the test engine 132. For example, the input may identify a method or class to exclude from the pattern identification/testing. As another example, the input may include testing parameters (test data) for specific methods. As another example, the input may include expected return objects and exceptions. In some embodiments, a package may include multiple classes, methods, etc., to be tested. Here, the developer may want to exclude one or more of the classes and/or methods from testing. In this case, the user may identify the classes and/or methods by names which may be provided in the pattern-based test code 150.

The input source code 140 may be analyzed for a pattern by the test engine 132. For example, patterns may be identified from method names, method signatures, annotations, fields, and the like, which may be read by the test engine 132 and compared with the identifiable patterns stored by the test engine 132 or platform associated therewith. When a pattern is recognized, a corresponding testing strategy is registered for the pattern. If no pattern is found, a generic strategy may be followed for the source code 140, or no testing may be performed. For example, the generic strategy may be a predefined fallback strategy if no pattern is recognized. The generic strategy may test some details of the source code such as null checks, extremities checks, and the like.

In the example where a pattern is identified, the pattern may be registered with the test engine 132. The registration process may be performed by a management component of the test engine 132 or associated with the test engine 132 and may include determining parameters to be passed for testing (if the parameters are not provided by the developer). In addition, parameter objects may be created by reflection or object proxy and may be passed into the method when the test engine 132 performs testing. In some embodiments, exceptions/expected return objects required by the method during testing may be determined if such information is not provided by the developer as an input. In some embodiments, the exceptions and expected return objects may be identified automatically by the management component based on reflection. In some embodiments, a kind of object that can be returned by the method may be determined, and the like. The management component may group methods which together make a patter or are co-dependent on each other.

After all steps are completed, the test session may be sent to the test engine 132 where the main test logic is executed on the source code 140. For example, the test engine 132 may compile and execute the source code 140 including any identified method/class patterns being tested. Furthermore, the test engine 132 may run/process any test cases corresponding to the identified patterns. The test cases may include testing procedures, the inputs, the testing conditions, and the like. The output of the testing may be compared to expected results. If an exception or an error occurs while testing the code, the test fails. As another example, if an output of a method does not match the expected output, the test may be determined to fail.

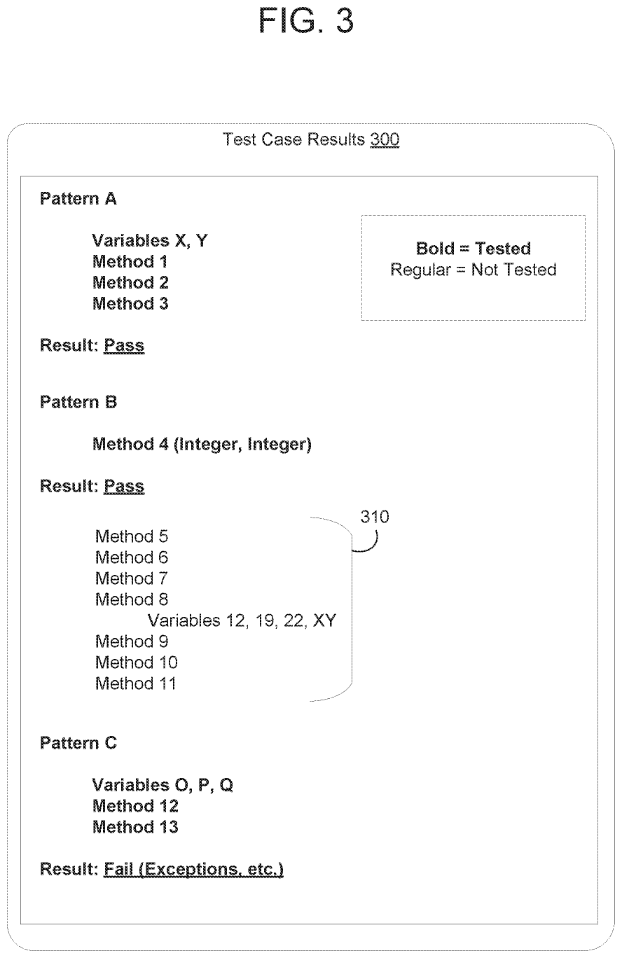

After all methods are tested, a detailed information may be logged in a log file and output to a console (e.g., user interface 300 shown in FIG. 3) providing information about which methods where tested, how they were grouped and what errors occurred. In particular, the user interface 300 shows a log file with source code that has been tested (highlighted in bold) and source code 310 that was not tested (shown as normal). The user interface 300 may correspond to an interface or a console of an IDE where the code is being developed. In this case, the source code 310 which was not tested may be distinguished from the source code which was tested using bold, highlighting, colors, etc. on the code stored in the log file. In addition, pass/fail results of the tested code may be provided within the user interface 300.

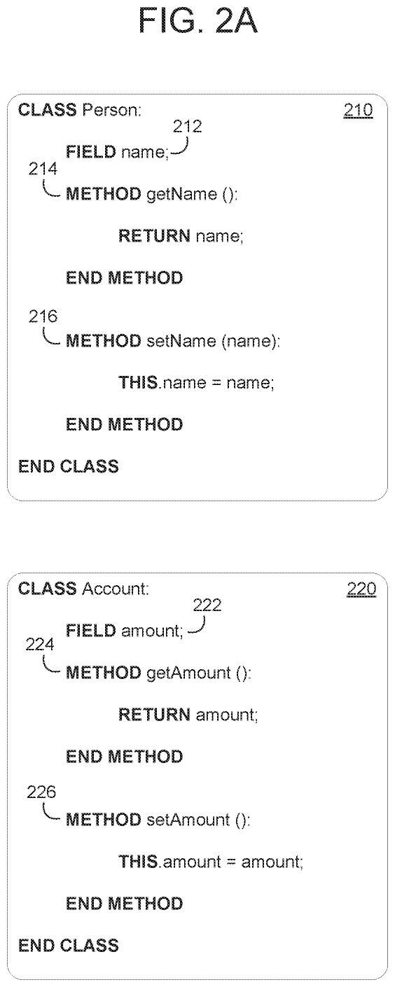

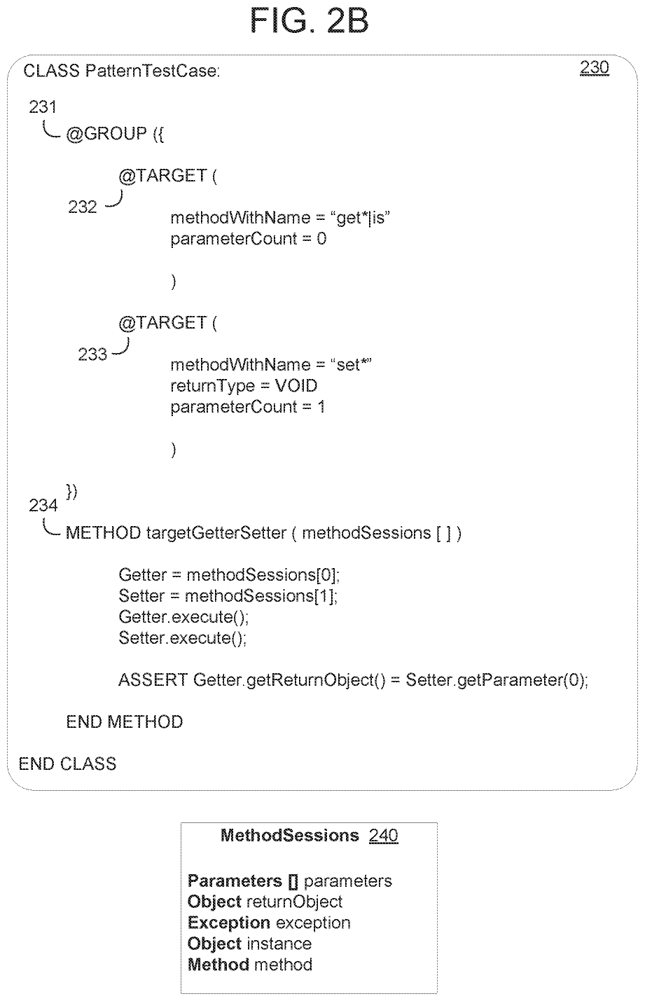

FIG. 2A illustrates examples of software objects 210 and 220 in accordance with an example embodiment, and FIG. 2B illustrates an example of test code 230 which includes an identifiable pattern 231 and a corresponding reusable test case 234 in accordance with an example embodiment. Referring to the example of FIG. 2A, two different software classes 210 and 220 include similar “get” and “set” patterns, respectively, which may be generically referred to as getter/setter patterns. In particular, a person class 210 includes a variable 212 which is commonly operated on by a first method 214 and then a second method 216. Likewise, an account class 220 includes a variable 222 which is commonly operated on by a first method 224 and then a second method 226.

In this example, the getter and setter functions in the person class 210 and the account class 220 have a similar pattern because the two methods are similar (get and set), the variable is similar (string), the combination is similar (set before get), etc. Each of these features may be used to identify a pattern. In this example, the identifiable pattern includes a method reading and a method writing the same attribute, respectively. Accordingly, a generic pattern identifier which groups together different getter and setter methods and a generic test case that tests whether the value returned by the getter is the same value set by the setter, may be used to commonly test the two cases. For example, the generic pattern identifier may look for specific textual strings in names of methods such as “get” and “set”. As another example, the generic pattern identifier may look for a combination of operations on a variable. As another example, the generic pattern identifier may look for the combination of method names, variables being processed, and the like.

FIG. 2B illustrates an example of test code 230 which includes an identifiable pattern 231 and a test method 234 for testing a pattern of source code identified as including the identifiable pattern 231. The test code 230 may correspond to the test code 150 shown in FIG. 1B. In the example of FIG. 2B, the test case includes a method called target entity 234 which tests for the getter setter pattern, and verifies if it is working correctly. Meanwhile, a group annotation within the identifiable pattern 231 may be used to group together different targets having a same pattern. Here, a target may be considered a programming element which can be a part of a pattern in the code. For example, a method, a field, an annotation, a class, and the like, can each be targets. With this, a developer can write a pattern detection code efficiently and doesn't have to learn any reflection element or any reflection programming of that specific programming language.

Annotation in a programming language is a way to provide metadata for a particular source code. The annotations are additions to the main source code which are typically identified with an @ symbol. Developers may use annotations to provide extra information to a compiler at runtime so processing becomes simpler.

However, the test case 234 may be written with reflection, to provide a unified reflection design that may be implemented in a programming language independent way. For example, the same API can be used across different programming languages. The test engine may encapsulate a method 240 in a method session after a pattern has been identified/caught. In this example, the method session 240 may be an isolated environment where the method can execute, so that anything else outside the method cannot affect the execution. The method session 240 may include capabilities such as auto generating parameters, storing a return object/exception after execution, changing annotated values, etc.

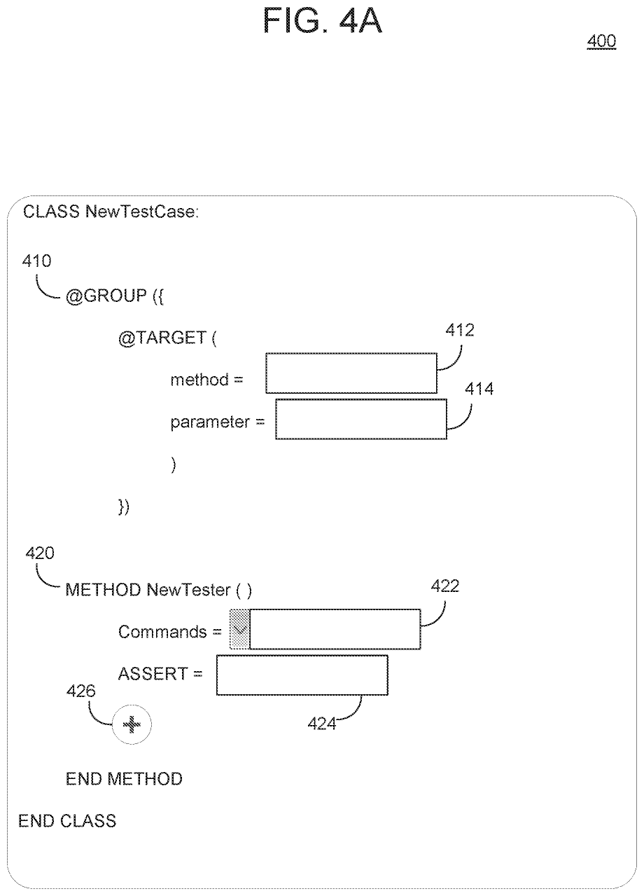

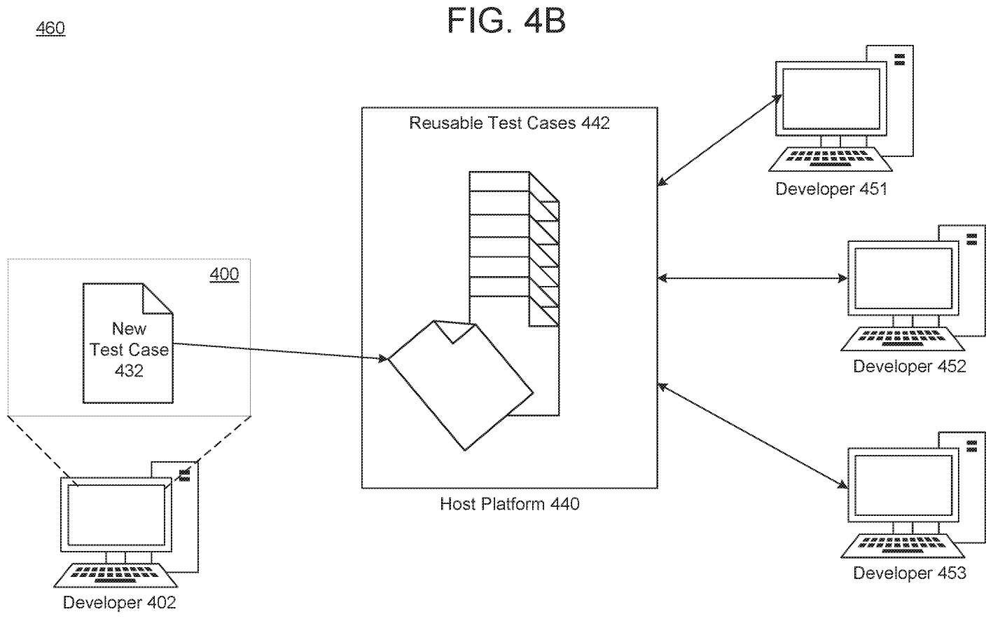

FIGS. 4A-4B illustrate a process of adding a new test code to a pool of reusable test cases in accordance with an example embodiment. Referring to FIG. 4A, a user interface 400 is shown which allows a user to design a new pattern and/or test case. In this example, a pattern template 410 enables a user to input methods and variables into text box fields 412 and 414, respectively. It should be appreciated that this is just one example. As another example, the user may be provided with a text entry field allowing the user to input a structure of code without a standard format. In addition, a test procedure template 420 provides the user with standard fields for inserting testing commands and assertions into fields 422 and 424, respectively. In addition, a user can select an add button 426 to add more commands, parameters, objects, etc., into the test procedure. Also, not shown is a method session template which may be provided to the user.

FIG. 4B illustrates a process 460 of a developer 402 submitting a new test case 432 built using the user interface 400 shown in FIG. 4A to a host platform 440 where it can be stored with a batch of reusable test cases 442 and used by other developers 451-453. The newly added test case 432 may include a generic pattern and test procedure that can be used on any class and/or programming language being used by developers 451-453. Accordingly, the pool of reusable test cases 442 may continue to grow over time based on new testing methods and changes in coding styles.

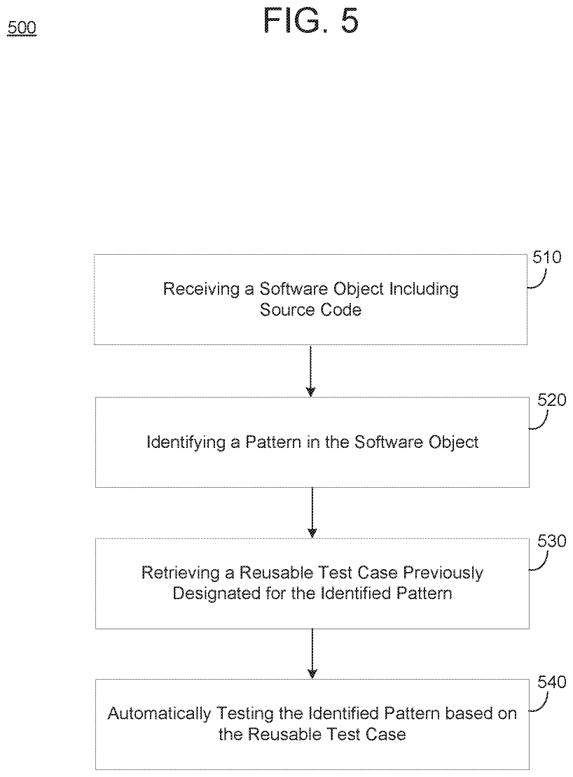

FIG. 5 illustrates a method 500 of identifying and testing a pattern within a software artifact in accordance with an example embodiment. For example, the method 500 may be performed by service or other program that is executing on a database node, a cloud platform, a server, a computing system (user device), a combination of devices/nodes, or the like. Referring to FIG. 5, in 510, the method may include receiving a software artifact which includes source code. For example, the software artifact may include lines of source code of a software class, a method, a software artifact, and the like. In some embodiments, an entire piece of software (application source code) may be tested at the same time. For convenience, the examples describe one piece of code being tested.

In 520, the method may include identifying a pattern in the software artifact based on one or more methods within the source code and a variable consumed by the one or more methods. For example, the pattern may be detected based on variables, methods, etc., that are included within the source. Similar patterns emerge across different classes of software, and different programming languages. For example, the get/set pattern is a common occurrence in different software classes. The example embodiments provide for predefined patterns which can be stored within a file, data store, etc., and which can be accessed by a test engine to identify whether source code includes any of the patterns.

In some embodiments, the identifying may include identifying a pattern based on method names of the one or more methods in the source code. As another example, the method may include identifying based on a predetermined combination of methods within a software class. As another example, the identifying may include identifying a predefined pattern of at least two methods interacting with a common variable within the source code of the software artifact.

In addition, the patterns may also be linked or paired with test cases including procedures for testing the corresponding pattern of source code. The test cases may be reusable across different classes, languages, etc. In 530, the method may include retrieving a reusable test case that is previously designated for testing the identified pattern. Further, in 540, the method may include automatically testing the identified pattern in the software artifact based on the reusable test case, and storing the testing results in a log file. For example, the reusable test case may include a specification of inputs, test procedures to be implemented during testing, and an expected output. In this example, the automatically testing may include executing the software artifact based on the test procedures and the inputs, and comparing execution results of the execution to the expected outputs.

In some embodiments, the retrieving may include identifying a reusable test case that is linked to the identified pattern from among a predetermined list of reusable test cases stored in a test file. In some embodiments, the method may further include adding a user-defined test case to the reusable tests cases in the test file in response to a user request. In some embodiments, the storing may include outputting or otherwise displaying the testing results to distinguish, within a user interface, a portion of the source code which has been automatically tested based on identified patterns form another portion of the source code which has not been tested and which has not been linked to any patterns.

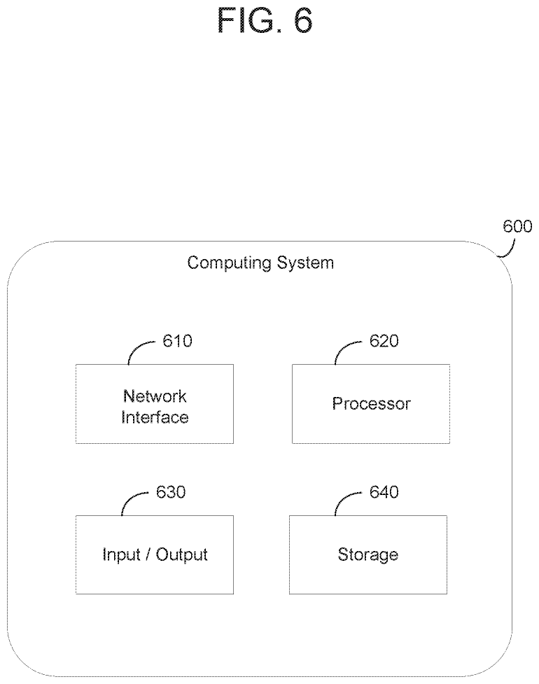

FIG. 6 illustrates a computing system 600 that may be used in any of the methods and processes described herein, in accordance with an example embodiment. For example, the computing system 600 may be a database node, a server, a cloud platform, a user device, or the like. In some embodiments, the computing system 600 may be distributed across multiple computing devices such as multiple database nodes. Referring to FIG. 6, the computing system 600 includes a network interface 610, a processor 620, an input/output 630, and a storage device 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage device 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the method shown in FIG. 5. According to various embodiments, the storage 640 may include a data store having a plurality of tables, partitions and sub-partitions. The storage 640 may be used to store database objects, records, items, entries, and the like. In some embodiments, the storage 640 may be configured to store instructions for executing a change service for controlling access to shared data objects.

According to various embodiments, the storage 640 may store a software artifact comprising source code. The processor 620 may identify a pattern in the software artifact based on one or more methods within the source code and a variable consumed by the one or more methods, retrieve a reusable test case that is previously designated for testing the identified pattern, and automatically test the identified pattern in the software artifact based on the reusable test case, and storing the testing results in a log file. For example, the reusable test case may be retrieved from a file or data store of the storage 640.

In some embodiments, the processor 620 may identify a pattern within the source code based on method names of the one or more methods in the source code. In some embodiments, the processor 620 may identify a predefined pattern that comprises a combination of methods. In some embodiments, the processor 620 may identify a predefined pattern of at least two methods interacting with a common variable within the source code of the software artifact. In some embodiments, the reusable test case may include a specification of inputs, test procedures to be implemented during testing, and an expected output. In some embodiments, the processor 620 may execute the software artifact based on the test procedures and the inputs, and compare execution results of the execution to the expected outputs.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store a software artifact comprising source code; and
a processor configured to identify a pattern in the software artifact based on one or more methods within the source code and a variable consumed by the one or more methods, retrieve a reusable test case that is previously designated for testing the identified pattern, automatically test the identified pattern in the software artifact based on the reusable test case, and store the testing results in a log file.

2. The computing system of claim 1, wherein the processor is configured to identify a pattern based on method names of the one or more methods in the source code.

3. The computing system of claim 1, wherein the processor is configured to identify a predefined pattern based on a combination of methods.

4. The computing system of claim 1, wherein the processor is configured to identify a predefined pattern of at least two methods interacting with a common variable within the source code of the software artifact.

5. The computing system of claim 1, wherein the reusable test case comprises a specification of inputs, test procedures to be implemented during testing, and an expected output.

6. The computing system of claim 5, wherein the processor is configured to execute the software artifact based on the test procedures and the inputs, and compare execution results of the execution to the expected outputs.

7. The computing system of claim 1, wherein the processor is configured to retrieve a reusable test case that is linked to the identified pattern from among a predetermined list of reusable test cases stored in a test file.

8. The computing system of claim 7, wherein the processor is further configured to add a user-defined test case to the reusable tests cases in the test file in response to a user request.

9. The computing system of claim 1, wherein the processor is configured to distinguish, within a user interface, a portion of the source code which has been automatically tested based on identified patterns form another portion of the source code which has not been tested and which has not been linked to any patterns.

10. The computing system of claim 1, wherein the reusable test case comprises a class-agnostic and a programming-language-agnostic test case.

11. A method comprising:
receiving a software artifact comprising source code;
identifying a pattern in the software artifact based on one or more methods within the source code and a variable consumed by the one or more methods;
retrieving a reusable test case that is previously designated for testing the identified pattern; and
automatically testing the identified pattern in the software artifact based on the reusable test case, and storing the testing results in a log file.

12. The method of claim 11, wherein the identifying the pattern comprises identifying a pattern based on method names of the one or more methods in the source code.

13. The method of claim 11, wherein the identifying the pattern comprises identifying a pattern based on a predetermined combination of methods within a software class.

14. The method of claim 11, wherein the identifying the pattern comprises identifying a predefined pattern of at least two methods interacting with a common variable within the source code of the software artifact.

15. The method of claim 11, wherein the reusable test case comprises a specification of inputs, test procedures to be implemented during testing, and an expected output.

16. The method of claim 15, wherein the automatically testing comprises executing the software artifact based on the test procedures and the inputs, and comparing execution results of the execution to the expected outputs.

17. The method of claim 11, wherein the retrieving comprises identifying a reusable test case that is linked to the identified pattern from among a predetermined list of reusable test cases stored in a test file.

18. The method of claim 17, further comprising adding a user-defined test case to the reusable tests cases in the test file in response to a user request.

19. The method of claim 11, wherein the storing comprises storing the testing results to distinguish, within a user interface, a portion of the source code which has been automatically tested based on identified patterns form another portion of the source code which has not been tested and which has not been linked to any patterns.

20. A non-transitory computer-readable medium comprising instructions which when executed by a processor cause a computer to perform a method comprising:
receiving a software artifact comprising source code;
identifying a pattern in the software artifact based on one or more methods within the source code and a variable consumed by the one or more methods;
retrieving a reusable test case that is previously designated for testing the identified pattern; and
automatically testing the identified pattern in the software artifact based on the reusable test case, and storing the testing results in a log file.
